(19) United States
(12) Patent Application Publication
(10) Pub. No.: US 2011/0082642 A1
(43) Pub. Date: Apr. 7, 2011

(54) METHOD AND SYSTEM FOR THE BUILDING UP OF A ROADMAP AND FOR THE DETERMINATION OF THE POSITION OF A VEHICLE

(76) Inventor: Per Magnussen, Bergen (NO)

(21) Appl. No.: 12/736,907

(22) PCT Filed: May 20, 2009
(86) PCT No.: PCT/NO2009/000191

§ 371 Date: Nov. 22, 2010

(30) Foreign Application Priority Data
May 22, 2008 (NO) 20082337

(51) Int. Cl. G01C 21/26

(52) U.S. Cl. 701/208

(57) ABSTRACT

A method is described for the building up of a special electronic roadmap for a vehicle, for the indication of the position of the vehicle on a road in a geographic area comprising a computer connected to a display and an internal memory connected to the computer, and which is based on an electronic roadmap provided and established with the help of data from a satellite navigation system, characterised in that a) the vehicle is fitted with sensors for the measurement of parameters such as movement and orientation of the vehicle, said parameters are registered and stored in true time and comprise: —its compass direction —Kr, (40)—its angle of incline —Sv, (41)—its angle of tilt —Kv, (42)—its height above sea level —(hoh), (43) and also —a radar picture of the road surface and the surrounding terrain and which change as the vehicle move forwards, (44) b) the vehicle is driven along a given route and said signals from the sensors in the electronic roadmap base are measured, registered and stored, said parameters are stored and added to the corresponding position coordinates for said route in the electronic roadmap, and c) with the measurements the exact position coordinates in the electronic roadmap are established for the vehicle with the help of data from a satellite navigation system, such as GPS registering, which are registered in, an in itself, known way. A method and a system are also described for establishing the position of a vehicle along a road without having to use data from satellite navigation.

### TECHNICAL AREA OF THE INVENTION

The present invention relates to a method for building up a special electronic roadmap for a vehicle, to give an indication of the position of the vehicle on a road in a geographic area, comprising a computer connected to a display and an internal memory connected to the computer, and which is based on an electronic roadmap provided and established with the help of data from a satellite navigation system.

The invention also relates to a method as described in the introduction to claim 6 for determining the position of a vehicle on a road in a geographic area, where the vehicle is fitted with the above mentioned special electronic road-map, a positioning system comprising a computer connected to a display and an internal-memory connected to the computer.

In addition, the invention relates to three variant methods where the differential treatment of signals from one single sensor can be used both as a part of the method to build up a roadmap and also to determine the position of the vehicle. With this solution one aims to be able to process measurement data from any of the described sensors and then register the changes as a function of distance travelled. Preferably, data will be registered for more than just one of these parameters and where comparison of data occurs against the roadmap in the database, the position on the road can thereby be displayed on the screen.

The invention also relates to a system in a car for determination of position. In addition, the invention relates to a system for determination of the position of a vehicle on any type of road.

The invention also relates to use of the electronic map in an ordinary vehicle as given in the introduction of the subsequent claim.

### BACKGROUND TO THE INVENTION

Today, it is well known to install a receiver apparatus in vehicles, which comprises a computer with a memory bank and a display screen. The system communicates via a receiver with a navigation system based on several geostationary satellites. This system is called GPS, which stands for “Global Positioning System”. The GPS system is a satellite based navigation system with at least 24 satellites placed in an orbit around the earth. The navigation system can give coordinates in true time in all the three dimensions, length, breadth and height. The satellites circle around the earth twice in a 24 hour period in a very exact orbit and send signals down to the ground. Alternatively, the satellite can be geostationary. The GPS receiver gets this information and uses three-point cross-checking to calculate the exact position of the user. This gives a two-dimensional indication of position, latitude and longitude. If the receiver has contact with four, or more, satellites, the position can be reported in three-dimensional format—length, breadth and height. The accuracy for a typical receiver in good weather can be three metres. The satellites contain very accurate atomic clocks and based on the difference between these, the GPS receiver can compare the point in time at which a signal is sent from a satellite with the point in time at which it was received. The time difference informs the GPS receiver how far away the satellite is. With distance measurements from several more satellites, the GPS receiver determines the position of the user. Many receivers can also show the exact position graphically on a map (source: Wikipedia).

However, there are disadvantages with today's navigation system which uses GPS, as there will be deviations at times where high mountains or buildings shut out signals. Normally, the GPS system does not work in tunnels either. There may also be deviations in calculating distances to turn-off points and arrival points.

With regard to prior art, reference is made to U.S. Pat. No. 6,233,523 and GB patent GB 2 060 306 which concerns navigation in flying. Common to both these known solutions is that one is dependent on satellite navigation, something one, according to the present invention, shall be completely free from. According to the invention it is given that the vehicle can comprise instruments to take down such satellite navigation, but according to the invention it is not required to use them.

### AIM OF THE INVENTION

It is therefore a first aim of the invention to provide a navigation system which finds its position by recognising and estimating distances through its own measurements in the vehicle.

It is a further aim to be able to make an electronic roadmap where position data in a terrain is determined by using data provided with the use of a number of measuring instruments associated with the vehicle, and where exact positions in the terrain on the map are determined from a satellite navigation system, for example, the system denoted GPS.

Furthermore, it is an aim of the invention to be able to give the driver of a vehicle information about the exact position along a road, WITHOUT the need for the use of the above mentioned satellite navigation. Consequently, it is an aim to make the determination of position independent of external sources for indication of position parameters, as one only need to use the sensor systems which are fitted in connection to the actual vehicle.

It is also an aim of the invention to provide a system with a signal processing where a number of measurements of a parameter are taken, and which are considered up against the distance covered along the road in metres so that the position can be determined.

### THE PRESENT INVENTION

According to a first aspect of the invention, a method is given as defined in the associated claim 1: A method is given which is characterised in that
a) the vehicle is fitted with one or more sensors to measure such parameters as movement and orientation of the vehicle, said parameters are registered and stored in true time and comprise at least one of:
   its compass direction (Kr);
   its angle of incline (Sv);
   its angle of tilt (Kv);
   its height above sea level (hoh); and
   a radar picture of the road surface and the surrounding terrain and which changes as the vehicle move forwards,
b) the vehicle is driven along a given route and said signals from one or more sensors in the electronic roadmap base are measured, registered and stored, said parameters are stored and added to the corresponding position coordinates for said route in the electronic roadmap; and
c) with the measurements the exact position coordinates of the vehicle are established in the electronic roadmap with the help of data from a satellite navigation system, such as on the basis of position navigation via satellite, such as GPS registrations, which are registered in a known way.

The preferred embodiments of this method are as given in the associated claims 2 to 5.

According to a second aspect of the invention, a method is given for determination of the position of a vehicle on a road in a geographic area, where the vehicle is fitted with a special electronic roadmap, a positioning system comprising a computer connected to a display screen and an internal memory connected to the computer, is characterised by the features that appear in the associated claim 6.

One set of measurement data from these five parameters is sufficient for the computer system to be able to determine the position of the vehicle on a road. The preferred embodiments can be seen in claims 7-9.

According to a third aspect of the invention, a method for building up an electronic roadmap and also determining the position of a vehicle on a road in a geographic area, where the vehicle is fitted with a special electronic roadmap, a positioning system comprising a computer connected to a display and an internal memory connected to the computer, is characterised in that (A) for a given amount of sensor measurements S₁ to Sₐ over a time interval t₁ to t₂ for a given sensor, where a is a whole number, a correlation is performed by corresponding database data D₁ to Dₘ where m is a whole number and m>a, such as Equation 1 has a maximum value to show the best correlation:

$${\sum }_{i = 1 ; k = 1}^{a ; m - k} [ {( {D}_{k + i} - {S}_{i} )}^{2} ] \qquad Eq . 1$$

as for a maximum value of Eq. 1 which has an associated value for k, where k is a whole number, a corresponding position for Dₘ at time t₂ one indicates where the car will be, as the result of Equation 1 can be provided for one or more of the signals from the sensors and can be compared with corresponding sensor data in the database which contains corresponding true position data, as can be seen in claim 10.

The two other methods based on the same idea with analysis of measurement data from a sensor over a given stretch of road travelled, are given in claims 11 and 12.

### The Vehicle Comprises:

a data unit in which an electronic roadmap is stored, said roadmap comprises a number of parameters for determination of any position along any type of road, a display unit for showing the navigation
a number of sensors for measuring and registering parameters for determining position for registering of
   compass direction—Kr, (40)
   angle of incline—Sv, (41)
   angle of tilt—Kv, (42)
   height above sea level—hoh, (43) and also
   a radar picture of the road surface and the surrounding terrain and which changes as the vehicle moves forward, (44).
and optionally that it comprises sensors for measuring of
   air pressure of the tyres (61)
   any electronic noise in the area through which the road runs (60)
   a camera (63) for optical photography of the surroundings that change as the vehicle moves forwards,
   distance measuring device for registering distance travelled (62) acceleration meter (64), and
   force of gravity measuring device (65), and also
Data unit with internet connection
Data unit with alternative communication system
Radio link
with the data unit also comprising a part unit which is set up to carry out comparisons between continuously registered position determining parameters and parameters installed in advance, and
said part unit is set up to deliver an indication of the exact position of the vehicle along the route to the display unit which shows the position.

The preferred embodiments appear in claims 15-18.

Relevant pre-programmed roadmaps for use in the present invention shall now be described in more detail. As a basis for the system and the method according to the invention, a basic electronic roadmap is used which describes the area very well. Such maps are supplied today by the largest map producers, for example, Blom, TeleAtlas and Navteq. Here, it can be mentioned that Blom, for example, has made a special map by scanning with laser from airplanes, namely generated with the help of photographs implemented immediately from above and diagonally, namely generated from photographs from various angles. This is a map they offer different suppliers of GPS units such as Tom Tom and Garmin, for example.

The map which is to be used in the present invention is based on such map bases as a series of new parameters shall be logged into the map base. Such a map base is the foundation of the system and, in developed form, it is described in this context as a “special electronic map”.

The electronic map is built up area for area at ground level. This is carried out in that the roadmap from a chosen map producer is used as a basis and all the measurements which the measuring and registering vehicle perform are put into the underlying map.

It is imagined that when the relevant sensors are fitted on a vehicle, the vehicle will form the basis for all measurements of reference points on the special electronic map.

According to the present invention, a system is provided that comprises a dedicated data unit that performs its own calculations for the operating parameters of the vehicle relative to the road on which the vehicle moves, as the system in addition uses the system in its own navigation map which is stored and pre-programmed in the vehicle's computer.

According to the invention the system functions in that all the calculations the vehicle performs are evaluated against the navigation map in the data unit and thereby one finds the position. In addition, this method can also be used during the building up of the map itself. Such evaluation can be carried out in many ways, for example:

(a) for a given number of sensor measurements S₁ to Sₐ over a time interval t₁ to t₂ for a given sensor, where a is a whole number, to make a correlation of corresponding database data D₁ to Dₘ, where m is a whole number and m>a, as Eq. 1 has a maximum value to show the best correlation:

$${\sum }_{i = 1 ; k = 1}^{a ; m - k} [ {( {D}_{k + i} - {S}_{i} )}^{2} ] \qquad Eq . 1$$

For maximum value of Eq. 1 which has an associated value for k, where k is a whole number, the corresponding position for Dₘ at time t₂ one refers to where the car is situated. The result from Eq. 1 can be obtained for one or more of the signals from the sensors and be compared with corresponding sensor data from the database which has corresponding true position data; or

(b) for a given number of sensor measurements S_{1,1} to S_{a,h} over a time interval t₁ to t₂ for sensor no. 1 to sensor no. h where a and h are whole numbers to generate a composite signal U₁ to Uₐ according to Eq. 2:

U₁=F(S_{i,1},S_{i,2} . . . S_{i,h}) Eq. 2

where F is a conversion function,
and thereafter to do a correlation of Uᵢ with the corresponding database data E₁ to Eₘ where m is a whole number and m>a and an E is composite database data, as Eq. 1 has a maximum value to show the best correlation:

$${\sum }_{i = 1 ; k = 1}^{a ; m - k} [ {( {E}_{k + i} - {U}_{i} )}^{2} ] \qquad Eq . 3$$

For a value of k, where k is a whole number which gives Eq. 3 a maximum value is corresponding position for composite data Eₘ at time t₂ that shows where the car is situated.

Alternatively, a combination of (a) and (b) for Eqs. 1 to 3 can be used to find a better solution between the need for computer calculating power and certainty that the indicated position of the car is correct. Alternatively, a neural network can be used to perform the data processing and to find the position of the car from the measurements from the sensors.

The navigation itself or the exact position of the vehicle is shown on a screen or a display which is fitted in connection to the dashboard of the vehicle.

The map which is stored electronically in the data unit is based on a GPS map which shows streets, roads and all typical map details.

In addition, the contour of the road surface is stored over the whole distance for every carriageway, i.e. that one has measured, registered and stored the following parameters for the road surface:

(i) its compass direction, Kr;
(ii) its angle of incline, Sv;
(iii) its tilt angle, Kv; and
(iv) its height above sea level, hoh.

Options (i) to (iv) can be implemented very cheaply by using silicon micro-fabricated sensors which are accurate, cheap and compact.

To implement this, the vehicle is fitted with the following instrumentation:
A display for showing the navigation
Measuring device for angle of roll and angle of tilt
Sensor for tyre air pressure
Measuring device for speed and distance travelled
Compass
Radar
Camera
Electronic noise sensor
A pre-programmed navigation map
Data unit with internet connection
Data unit with alternative communication system
The system also comprises a GPS unit and uses such signals as an additional reference
Radio link
Acceleration meter
Height meter

The system according to the invention measures and registers these parameters continuously as a function of distance travelled V, i.e. the installation registers changes in the compass direction of the road, the angle of incline, tilt and height above sea level all the time.

With regard to the compass, it is preferred to use an electronic/digital compass that shows the geographic direction and which transfers the direction of the vehicle to the database.

All measured values that change over the distance travelled form a starting point for determination of the position, in that the change of the measured values as a consequence of distance travelled is compared with the corresponding data which is measured, registered and stored in the computer.

$$P = f Δ Kr + \frac{Δ Sv}{Δ V} + \frac{Δ Kv}{Δ V} + \frac{Δ hoh}{Δ V} \qquad Eq . 4$$

In addition, alternative parameters such as the air pressure of the tyres, speed and distance travelled a radar picture of the road surface and the surrounding terrain, and any electronic noise in the area through which the road runs, are measured and registered. The electronic noise measuring device registers the level of electronic signals and magnetism and transfers these to the database where they are evaluated against permitted values. Alternatively, the system may also comprise an optical camera which continuously photographs the surroundings that change as the vehicle moves forwards.

Furthermore, the tyres of the vehicle preferably comprise a measuring device which registers the tyre pressure and transmits this information to the systems which can thereby carry out a compensation so that this tyre pressure can change. More specifically, the system can comprise a radio “Bluetooth” unit signal connection from the wheels. Bluetooth is an internationally known near-field radio (NFR) communication system: Other NFR solutions can alternatively, or in addition, be used to implement the invention.

The real values for these parameters for a given stretch of road are measured in advance and stored in the map storage of the computer. When such measurements are done in advance, a method is used where the vehicle drives a given distance, the measurement values are registered, a radar picture, terrain photograph and electronic noise are registered and the data system performs a comparison. When there is a complete, or approximately complete, agreement between measured and stored values for these parameters, this is shown on the display as an accurate momentary position for the vehicle on the actual stretch of road. The changes in positioning for the vehicle along the road, are shown continuously on the map as is common on today's roadmaps. A database can thereby be established where one has map positions and corresponding sensor signals which are expected for the positions.

The big advantage with the present invention is that all necessary instrumentation and data processing to determine a position is built into the vehicle and one is therefore not dependent on external instrumentation or signals to determine the position, for example, GPS signals. Because all modem internal memory is very cheap, computer power is cheap, and sensors as mentioned above, for example, a compass and a silicon microfabricated acceleration meter are cheap, it is possible to offer a system which is cheaper and more reliable than today's GPS solutions to find positions of the car in a given terrain. In other words, the present invention is in contrast to today's map systems where one is dependent on a network of satellites which orbit the globe to be able to carry out a certain position determination.

The calculations that the data unit carries out from one or more of the following to generate sensor signals are:
It measures the angle α (angle of incline) of the car to the road surface in the direction of travel. The angle α which then appears is in relation to the horizontal angle which is 0
It measures the angle β (angle of tilt) to the road surface in the direction of driving. The angle β which then appears is in relation to the horizontal angle which is 0. This angle is measured on an axis which is 90 degrees in relation to measurement of the angle of tilt
The speed and distance travelled measuring device provides information about speed by calculations of distance travelled
The compass provides information about geographic direction
The radar provides information about the distance to the terrain and buildings
The electronic noise sensor has a receiver for electronic signals and magnetism. If the sensor picks up higher signal values than expected and the values can influence some of the measuring units, these are recalculated in the data unit and used to correct the measured values
With the camera a picture is registered of the surrounding terrain
Comparison of values for height in relation to the sea level
Speed changes (acceleration/deceleration) are measured with an acceleration meter
Measuring instrument for measuring changes in the force of gravity along the road

A digital navigation map is stored in the database which has stored the same measuring units and the data which this system uses. That means the vehicle has driven through all the actual stretches of road of the navigation map and registered all the existing data in an internal memory.

With the present invention one obtains the following advantages in relation to previously known systems for provision of driving positions on a stretch of road:
The system navigates under all conditions and determines the position more accurately
With fewer deviations in the navigation the driver will more easily keep his eyes on the traffic and the use is more pleasant
When the system contributes to fewer interruptions during deviations it may also lead to safer driving and thus fewer traffic accidents

### How the System Works in Practice:

When one starts the car and has chosen the driving route the system will carry out its own calculations which are then evaluated against the pre-programmed navigation map. The place/position in which one finds oneself will then be recognised by the system. Thus, one has the position of the starting point and the navigation can begin.

### DESCRIPTION OF FIGURES

The invention shall now be described in more detail with reference to the enclosed figures, in which:

FIG. 1 shows a flow diagram for how the system according to the invention can be connected by elements.

FIG. 2: Measuring the Angle of Incline.

The principle for measuring the angle of incline is shown. In the case shown the angle of incline α for the car is about plus 10 to 11 degrees. The signal for momentary, exact angle of incline is sent to the computer.

FIG. 3. Measuring Angle of Tilt.

A corresponding typical angle measuring device 14 is shown for measuring tilting. Here, the angle measuring device shows the angle of tilt β which is minus 8 degrees. The signal for momentary, exact angle of tilt is sent to the computer.

FIG. 4. Placing the Sensor for Angle Measurement.

As shown in FIG. 3, a sensor is placed between the front wheels 16, 18. The sensor 17 is placed on a bar 20, which is fastened in the centre of the wheels to have a stable location and to avoid movements from the chassis influencing the measurements. Attention is also given to that sudden movements due to objects, bumps or holes in the road shall not influence the calculation with regard to angle measurement. The computer programme is set up to disregard such sudden movement changes.

FIG. 5

Air pressure sensors 22, 24 measure the air pressure in the tyres before start. The level forms the basic level and sets the standard for the measurements of the angles of incline and tilt. For deviations in the air pressure in one of the tyres during driving, the system performs a correction to maintain the set standard for the vehicle compared to the start.

FIG. 6

A vehicle 10 comprises a radar 26 placed at the highest point of the car and is an encapsulated unit which is adapted to the outer contours of the car. The radar preferably measures in a radius of 360 degrees. The radar seeks fixed points and ignores traffic related units. This is made by references to the pre-programmed road map. The function of the radar is to recognise the terrain and buildings that lie in the map. The radar shall, similar to the other measuring units, recognise locations in the map. The calculation put together will then give the position. Correspondingly, the unit 26 can comprise a camera 28 which continuously takes photographs of the surroundings which pass by when the vehicle moves.

For measuring speed and distance travelled, a sensor is applied that collects this data from the car speedometer. The measurements are then evaluated against the data in the pre-programmed navigation map and will give references/acknowledgements for the calculation of the position.

Hardware unit. This unit contains a database with navigation map and functions as a computer with internet connection.

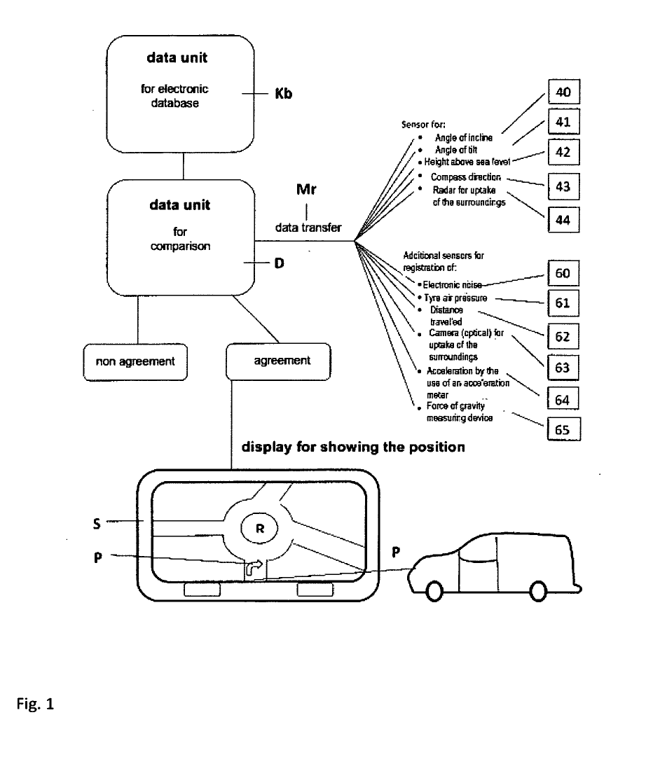

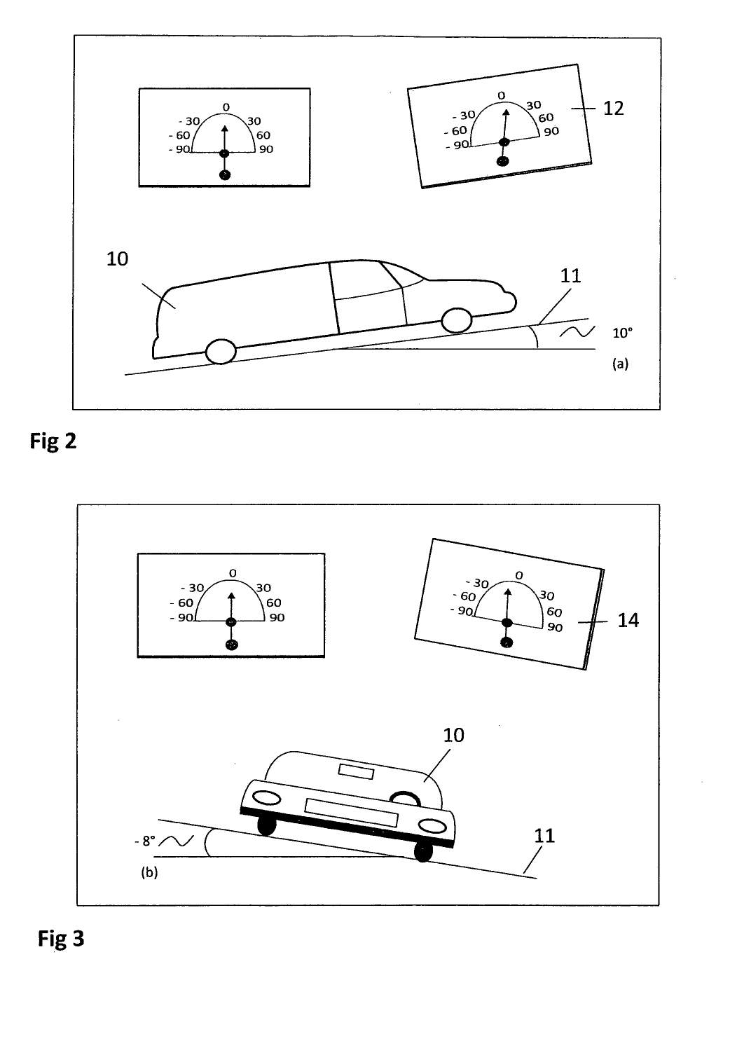

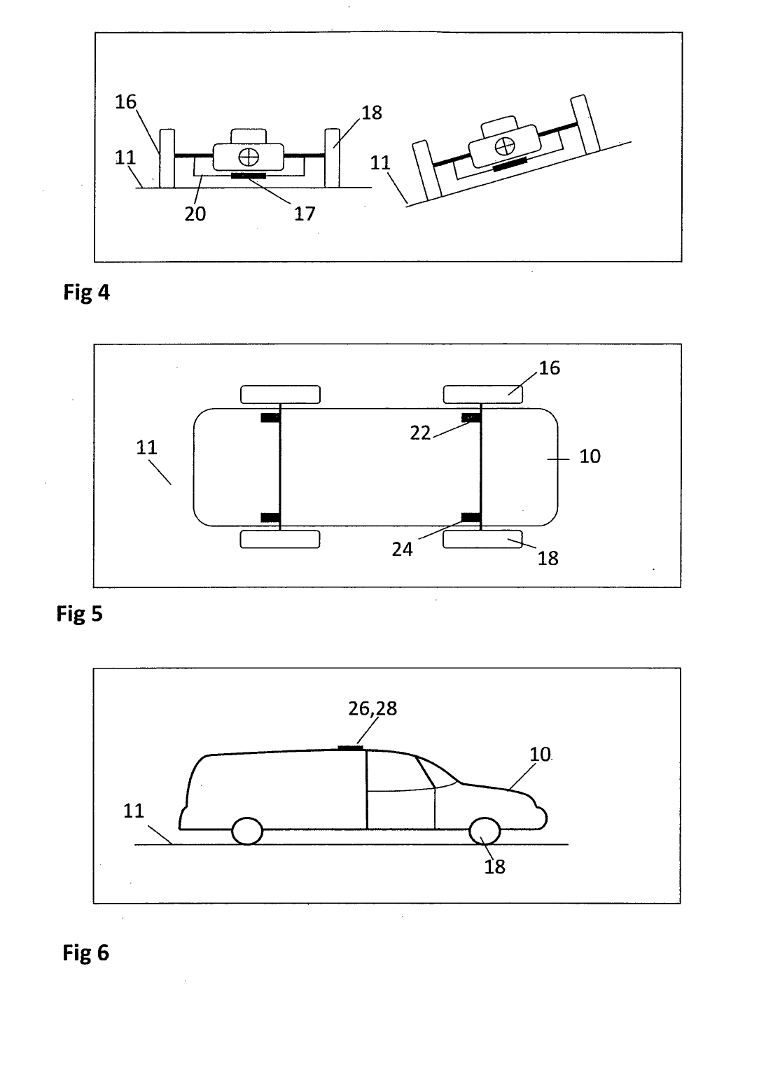

FIG. 1 shows schematically how the system is built up. A number of measuring sensors M in the vehicle transfer the results from the measuring Mr to a data unit D for purposes of comparison. These data are compared with the data that lie in the map base Kb. When there is agreement between the measured parameters and the parameters from the map base, the actual geographic point of the position of the vehicle is established. This is shown on the screen S which, for example, is placed in the car dashboard. As an illustration, it is indicated on the actual map with an arrow P that the vehicle is on its way into a roundabout R and where the arrow P shows the direction of travel. If there is no agreement, i.e. the computer does not recognise the set of parameters that comes from the sensor, this is also indicated on the screen with a feely chosen symbol.

The system can also be fitted with a unit for alternative communication such as a radio receiver, radio transmitter, mobile telephone and possibilities for other communication systems. If the internet is not used, alternative communication systems shall be used, or both can be used simultaneously.

For display of the navigation, the system comprises a display unit which is placed centrally in the car dashboard. The display is set up for operation and showing of the navigation. The screen is a touch screen so that the driver can easily collect and display on the screen all the data that is considered necessary.

### Software and Function

Software: For implementing the invention a software programme is used which collects registrations/data from all the measuring units as given above. Furthermore, this data is evaluated against information in the database where the pre-programmed navigation map is found. The programme then calculates the position of the car. The position is transferred to be shown in the display on the dashboard. The programme also handles updating of the map via the internet. In addition, it will also receive updates if the internet drops out. This occurs via the unit for alternative communication.

The computing programme is stored in machine-readable data media and can be run on a computer to implement the correlation calculations related to Eq. 1 to Eq. 4 given above, for example, to implement the invention.

The database in the car can be organised in many different ways:
(a) the database is a collection of data where the information about position is related to corresponding expected sensor signal information defined for every type of sensor individually and is prepared in advance. Later during driving, the sampling of each sensor signal is correlated with corresponding signal information in the database. For every sensor signal the best possible correct position of the car/vehicle is calculated via correlations; if the positions thus calculated with correlation correspond with each other within a given threshold of accuracy, it is then identified by the software product to indicate the most accurate position of the car/vehicle; or
(b) a collection of data where the information about position is related to corresponding, expected sensor signal information defined as an artificially composed signal derived from signals from several different types of sensors (i.e. “a composite signal”); sampling of each sensor signal during driving is revised to generate a form of a composite signal which thereafter is correlated with corresponding composite signal information from the database; and from the correlation of the measured composite signal with the composite database signal a position of the car/vehicle is estimated;
(c) or a combination of methods (a) and (b) above.

The method (a) is potentially more accurate than the method (b), but the method (a) requires more computer power compared to the method (b). The method (c) can have advantages from both methods (a) and (b) and is an alternative implementation of the invention.

Database: The database is updated continuously with information about the existing vehicle in the form of its width, height, length and construction details significant for the system, and information about electronic equipment that can disturb/affect the measuring units of the system.

In addition, the pre-programmed navigation map is installed in the database.

Updating: In this system one places much emphasis on the navigation map containing the latest updates about changes in driving conditions at all times. This is because the driver shall have as much confidence as possible in the navigation unit, something which makes navigation simpler and thus the driving more comfortable and safe.

The pre-programmed navigation map in the system is arranged to be updated from a traffic centre.

It is beneficial if the data corresponding to the data map stored in the internal memory in the car is updated via radio transmissions, for example, via a mobile phone network or via wireless internet, etc.

Transfer of updating: The system is connected to the internet for transfer of updates. It has been found that this possibility does not always function today. Therefore, the system has an alternative communication unit. The speed of transfer via this is not as fast, but the structure of the pre-programmed navigation map has a form which takes this into account. This is because the divisions on the map are built-up in zones which contain different categories where one can change status. If any changes occur in the zone one is navigating in, it is only the change that is transferred via the alternative communication system. The transfer via the alternative communication system is coded, alternatively the communication system or internet connection can lie and search after updates in the relevant zone.

The system according to the invention will function under all driving conditions and is independent of signals from transmitters or emitters outside the vehicle. The navigation gives a more precise number around the position. The build-up of the pre-programmed navigation map gives an identity to all positions. When the system in the car makes its own calculations, these are summed up and an identity is built up which is recognised by the map in the database.

1. Method for the building up of a special electronic roadmap for a vehicle to indicate the position of the vehicle on a road in a geographic area, comprising a computer connected to a display and an internal memory connected to the computer, and which is based on an electronic roadmap provided and established with the help of data from a satellite navigation system,
characterised in that
a) the vehicle is fitted with sensors to measure parameters such as movement and orientation of the vehicle, said parameters are registered and stored in true time and comprise:
its compass direction—(Kr), (40)
its angle of incline—(Sv), (41)
its angle of tilt—(Kv), (42)
its height above sea level—(hoh), (43) and also
a radar picture of the road surface and the surrounding terrain and which changes as the vehicle moves forwards (44)
b) the vehicle is driven along a given route where said signals from the sensors in the electronic roadmap base are measured, registered and stored, said parameters are stored and added to the corresponding position coordinates for said route in the electronic roadmap, and
c) with the measurements the exact position coordinates for the vehicle are established in the electronic roadmap with the help of data from a satellite navigation system, such as GPS registrations, which are registered in, an in itself, known way.

2. Method according to claim 1, characterised in that in addition, one measures and registers the following parameters:
air pressure of the tyres (61),
existing electronic noise in the area through which the road runs (60),
a camera (63) for optical photography of the surroundings that change as the vehicle moves forwards
distance measurements for registering distance travelled (62)
acceleration meter (64), and
force of gravity measuring device (65).

3. Method according to one of the claims 1 to 2, characterised in that said parameters are continuously registered as a function of distance travelled V, i.e. that changes in the compass direction of the road, angles of incline, tilt and height above sea level and also changes in all the other parameters that are given in claim 2 are continuously registered and stored.

4. Method according to claim 1, characterised in that the angle measurements for incline and tilting are made with the help of one or more sensors (17) which are placed between the front wheels (16, 18) of the vehicle such as on a bar (20), which is fastened in the centre of the wheels to have a stable location and to avoid that movements from the chassis influence the measurements.

5. Method according to claim 1, characterised in that an electronic map is provided which in addition to the original position coordinates for the whole stretch of road, also comprises stored all the relevant parameters that are given in claim 3, whereupon the driving position shown on the display is independent of external satellite navigation.

6. Method for determination of the position of a vehicle on a road in a geographic area, where the vehicle is fitted with a special electronic roadmap, a positioning system comprising a computer connected to a display and an internal memory connected to the computer,
characterised in that
a) the vehicle is driven along any type of road and where signals from sensors for the following parameters are measured and registered in true time:
its compass direction (Kr),
its angle of incline (Sv),
its angle of tilt (Kv),
its height above sea level (hoh), and also
that a radar picture is formed of the road surface and the surrounding terrain and which changes as the vehicle move forwards,
b) the received signals are transferred and processed and compared with the previously taken up, corresponding, true time coordinate parameters, as an agreement between the measured values gives an indication of the position of the vehicle on the road, and
c) the relevant information about the position of the vehicle is shown via the special electronic roadmap on the display.

7. Method according to claim 6, characterised in that in addition, one measures and registers the following parameters:
air pressure of the tyres (61),
existing electronic noise in the area through which the road runs (60),
a camera (63) for optical photography of the surroundings that change as the vehicle moves forwards,
distance measurements for registering distance travelled (62),
acceleration meter (64), and
force of gravity measuring device (65).

8. Method according to claim 7, characterised in that said parameters are registered continuously as a function of distance travelled V, i.e. that changes in the compass direction of the road, angle of incline, tilt and height above sea level and also changes in all the other parameters that are given are continuously registered and stored.

9. Method according to one of the claims 6 to 8, characterised in that the angle measurements for incline and tilt are made with the help of one or more sensors (17) which are placed between the front wheels (16, 18) of the vehicle, such as on a bar (20), which is fastened in the centre of the wheels to have a stable location and to avoid that movements from the chassis influence the measurements as it also taken into consideration that sudden movements due to objects, bumps or holes in the road surface shall not influence the calculations in relation to reading of angles that the computer programme is set up to ignore such sudden movement changes.

10. Method for the building up of an electronic roadmap, and also for determining the position of a vehicle on a road in a geographic area, where the vehicle is fitted with a special electronic roadmap, a positioning system comprising a computer connected to a display and an internal memory connected to the computer,
characterised in that
a) for a given number of sensor measurements S₁ to Sₐ over a time interval t₁ to t₂ for a given sensor, where a is a whole number, a correlation is performed for corresponding database data D₁ to Dₘ where m is a whole number and m>a such as Equation 1 has a maximum value to show the best correlation
$${\sum }_{i = 1 ; k = 1}^{a ; m - k} [ {( {D}_{k + i} - {S}_{i} )}^{2} ] \qquad Eq . 1$$
as, for a maximum value of Eq. 1 which has an associated value for k, where k is a whole number, is corresponding position for Dₘ at time t₂ shows where the car is, as the result of Equation 1 can be provided for one or more of the signals from the sensors and be compared with corresponding sensor data in the database which has corresponding true position data.

11. Method for the building up of an electric roadmap, and also determining the position of a vehicle on a road in a geographic area, where the vehicle is fitted with a special electronic roadmap, a positioning system comprising a computer connected to a display and an internal memory connected to the computer,
characterised in that
b) for a given number of sensor measurements S_{1,1} to S_{a,h} over a time interval t₁ to t₂ for sensor no. 1 to sensor no. h where a and h are whole numbers, a composite signal U₁ to Uₐ is generated in accordance with the equation Eq. 2:
Uᵢ=F(S_{i,1},S_{i,2} . . . S_{i,h}) Eq. 2
where F is a conversion function,
whereupon a correlation of Uᵢ is carried out with the corresponding database data E₁ to Eₘ where m is a whole number and m>a and an E is composite database data, as Eq. 1 has a maximum value to show the best correlation:
$${\sum }_{i = 1 ; k = 1}^{a ; m - k} [ {( {E}_{k + i} - {U}_{i} )}^{2} ] \qquad Eq . 3$$
as, for a value of k, where k is a whole number, which gives the Eq. 3 a maximum value, is corresponding to the position for composite data Eₘ at time t₂ which shows where the car is situated.

12. Method for building up of an electronic roadmap, and also for determination of the position of a vehicle on a road in a geographic area, where the vehicle is fitted with a special electronic roadmap, a positioning system comprising a computer connected to a display and an internal memory connected to the computer, characterised by a combination of a) and b) for Eq. 1 to 3 is used to find the best solution between the need for computer calculating power and certainty that the indicated position of the car is correct, possibly that a neural network is used to perform the data processing and to find the position of the car from the measurements from the sensors.

13. Method according to one of the claim 10, 11 or 12, characterised in that the method processes measurement data chosen from the position determining parameters as given in the claims 6 and 7.

14. System for determination of the position of a vehicle on any type of road, characterised in that the vehicle comprises:
a data unit in which an electronic roadmap is stored, said roadmap comprises a number of parameters for determination of any position along routes, a display unit for showing the navigation
a number of sensors for measuring and registering position determining
parameters for registration of:
compass direction—Kr, (40)
angle of incline—Sv, (41)
angle of tilt—Kv, (42)
height above sea level—(hoh), (43) and also
a radar picture of the road surface and the surrounding terrain
which changes as the vehicle move forwards, (44) and optionally that it comprises sensors for measurements of
air pressure of the tyres (61),
any electronic noise in the area through which the road runs (60).
a camera (63) for optical photography of the surroundings that change as the vehicle moves forwards
distance measuring unit for registering distance travelled (62)
acceleration meter (64), and
force of gravity measuring device (65), and also
Data unit with internet connection
Data unit with alternative communication system
Radio link
as the data unit also comprises a part unit which is set up to perform a comparison between continuously registered position determining parameters and the parameters installed in advance, and
said part unit is set up to send out an indication of the exact position of the vehicle along the route to the display unit which shows the position.

15. System according to claim 14, characterised in that the display unit is a screen that shows the road and the position on the map.

16. System according to one of the claims 14 to 15, characterised in that a measuring body for registering the position determining parameters comprises a sensor arranged between the front wheels (16, 18) of the vehicle, placed on a bar (20), which is fastened at the centre of the wheels to have a stable location and to avoid that movements of the chassis influence the measurements.

17. System according to one of the claims 14 to 16, characterised in that the measuring bodies for registering the position determining parameters comprise an air pressure sensor (22, 24) connected to each tyre for measuring the air pressure in the tyres.

18. System according to one of the claims 14 to 17, characterised in that the measuring bodies for registering the position determining parameters comprise a radar (26) placed at the highest point of the car and is an encapsulated, flat unit adapted to the outer contour of the car.
